(19) United States
(12) Patent Application Publication
(10) Pub. No.: US 2026/0231896 A1
(43) Pub. Date: Aug. 13, 2026

(54) STRINGER FOR A FLOORING, SUITABLE FOR THE GROUND OF AN ENCLOSURE FOR LIVESTOCK, IN PARTICULAR CATTLE

(71) Applicant: GROUP ELASTOTECK, Mouzeil (FR)

(72) Inventor: Jean-Vincent BIORET, PETIT MARS (FR)

(21) Appl. No.: 19/153,844

(22) PCT Filed: Feb. 5, 2024
(86) PCT No.: PCT/EP2024/052817

§ 371 Date: Aug. 5, 2025

(30) Foreign Application Priority Data
Feb. 6, 2023 (FR) 2301108

(51) Int. Cl. A01K 1/01

(52) U.S. Cl. CPC A01K 1/0103; A01K 1/0135

(57) ABSTRACT

The present invention relates to a longitudinal member for a floor covering suitable for the floor of an enclosure for rearing animals, in particular cattle. The longitudinal member (1) comprises a primary profile (5) made of an elastic material, which comprises: ·a central strip (53) forming a rib intended to be accommodated in a complementary groove (R) formed in the floor, comprising an upper face (531) defining a longitudinal groove (51); ·two lateral strips (54) extending the central strip (53) and extending on either side of the longitudinal opening (511), comprising an upper face (541) intended to form a bearing face for the animals and a lower face (542) intended to rest on the floor along the groove (R).

### TECHNICAL FIELD OF THE INVENTION

The present invention relates to the technical field of flooring, suitable for the ground of an enclosure for livestock, in particular cattle, in particular for collecting excreta.

It relates in particular to a stringer for a flooring, suitable for the ground of an enclosure for livestock, in particular cattle.

The invention also relates to a system for collecting excreta flowing on the ground and an enclosure fitted with such a collection system.

### State of the Art

Animal comfort is a determining parameter in livestock efficiency, which influences in particular the animal health, the way they eat, as well as their fertility and longevity.

In stable, this comfort involves in particular a rapid and efficient disposal of the excreta produced by the animals.

This excreta management must indeed make it possible to reduce the gas emanations and the proliferation of bacteria in the livestock enclosure, and hence to improve the ambient conditions and the sanitary performances.

These excreta are moreover liable to make the ground slippery, with the risks of fall and injuries that ensue therefrom.

More generally, an excessively wet flooring is liable to cause sanitary problems at the animal feet, in particular lameness, which constitutes a major livestock health problem. Among the infections at the origin of lameness, digital dermatitis, also called “Mortellaro disease”, is the most problematic.

There thus exists a need for technical solutions that make it possible to reduce moisture of the livestock enclosure ground bearing surfaces while ensuring an efficient disposal of the liquids (in particular, urines), advantageously without requiring for that purpose significant structural works, so as to improve the grip conditions and the sanitary conditions of the animals.

There also exists an interest for simple solutions that permit a certain separation of urines and faeces, so as to limit the production of ammonia in livestock enclosures.

In order to remedy these drawbacks of the state of the art, collection systems exist which comprise excreta conveyor means within guiding profiles, so as to generate a circulation of excreta along those guiding profiles, towards collection means.

Such collection means allow an automatic and continuous disposal of the liquids (in particular, urines), which results in a certain reduction in ammonia production.

But, in practice, it would be interesting to further improve the efficiency of such collection systems, so as to optimize the separation of urines and faeces and to limit the production of ammonia.

Moreover, it is useful to be able to further simplify the implementation of such collection systems in a livestock enclosure, both new and existing ones (improvement or renovation), without requiring for that purpose the implementation of significant structural works.

### Disclosure of the Invention

In order to remedy the above-mentioned drawback of the state of the art, the present invention proposes a stringer for a flooring, suitable for the ground of an enclosure for livestock, in particular cattle.

The stringer comprises a primary profile, made of an elastic material optionally with textile reinforcement, which comprises a central strip and two side strips.

The central strip, forming a rib intended to be housed in a complementary slot formed in the floor, has two opposite faces:
a concave, upper face, defining a longitudinal groove having a longitudinal opening intended to open out upward, and
a convex, lower face, forming said rib.

The two side strips, extending said central strip and extending on either side of said longitudinal opening, have two opposite faces:
an upper surface, intended to form a resting surface for the animals, and
a lower surface, intended to rest on the ground, along said slot.

Such a primary profile makes it possible to absorb the mechanical stresses exerted in particular by the animal hooves, which avoids the deformations and breaks on other parts of the collection system.

The other parts of the collection system, in particular made of plastic material, are protected due to the interface formed by the primary profile.

Other non-limiting and advantageous features of the product according to the invention, taken individually or according to all the technically possible combinations, are the following:
the primary profile has a thickness from 3 to 30 mm;
the side strips have a thickness that increases from the central strip, for example from 3-7 mm to 20-30 mm, for example with a slope from 2 to 5%;
the side strips have a width from 5 to 100 cm;
the upper face of the side strips include slots opening out at said longitudinal opening and/or an anti-slip relief;
the central strip has two side walls connected by a bottom wall, defining said longitudinal groove.

According to a preferred embodiment, said stringer also comprises a secondary profile, made of plastic material, added in the longitudinal groove of said central strip; said secondary profile conforms said longitudinal groove and defines a longitudinal groove having a longitudinal opening that opens out towards the longitudinal opening of said longitudinal groove of the primary profile.
the secondary profile, generally U-shaped, has two side partitions and a bottom partition; preferably, the secondary profile has a discontinuous intermediate structure extending between the side partitions and remote from the bottom partition, to define a lower chamber and an upper chamber intended to receive conveyor means comprising a driving member that is associated with operating means;
the longitudinal groove of the primary profile diverges from the bottom wall towards the longitudinal opening;
the two side walls of the central strip of said main profile have facing surfaces that are provided with stop means suitable for an interlocking of the secondary profile by elastic deformation.

The present invention also relates to a system for collecting excreta flowing on the ground of an enclosure for livestock, for example cattle.

This collection system is characterized in that it comprises:
(i) a flooring that comprises:
at least one stringer according to the invention,
at least one pair of side blades, intended to be added on either side of said stringer and each having a downward slope towards said at least one longitudinal opening of the primary profile,
(ii) conveyor means for conveying the excreta within said longitudinal groove of said at least one primary profile, so as to generate a circulation of said excreta along said at least one longitudinal groove of said at least one primary profile and towards collection means,
said conveyor means comprise a driving member that is associated with operating means.

Preferably, each side blade has a slope from 1 to 5%, preferably from 2 to 4%.

Also preferably, each side blade has a width from 500 to 2000 mm.

Still preferably, said driving member has two superimposed parts in said at least one longitudinal groove:
an upper part, adapted to convey solid excreta in a first conveying direction, while allowing the flowing of liquid excreta, and
a lower part, adapted to convey liquid excreta flowing from said upper part, in a second conveying direction, which is opposite to said first direction.

The invention also relates to an enclosure for livestock, for example cattle, wherein said enclosure includes:
a circulation corridor, having a longitudinal axis and fitted with a collection system according to the invention,
collection means for collecting excreta circulating along said at least one longitudinal groove.

Of course, the different features, alternatives and embodiments of the invention can be associated with each other according to various combinations, insofar as they are not mutually incompatible or exclusive.

### DETAILED DESCRIPTION OF THE INVENTION

Moreover, various other features of the invention emerge from the appended description made with reference to the drawings that illustrate non-limiting embodiments of the invention, and wherein:

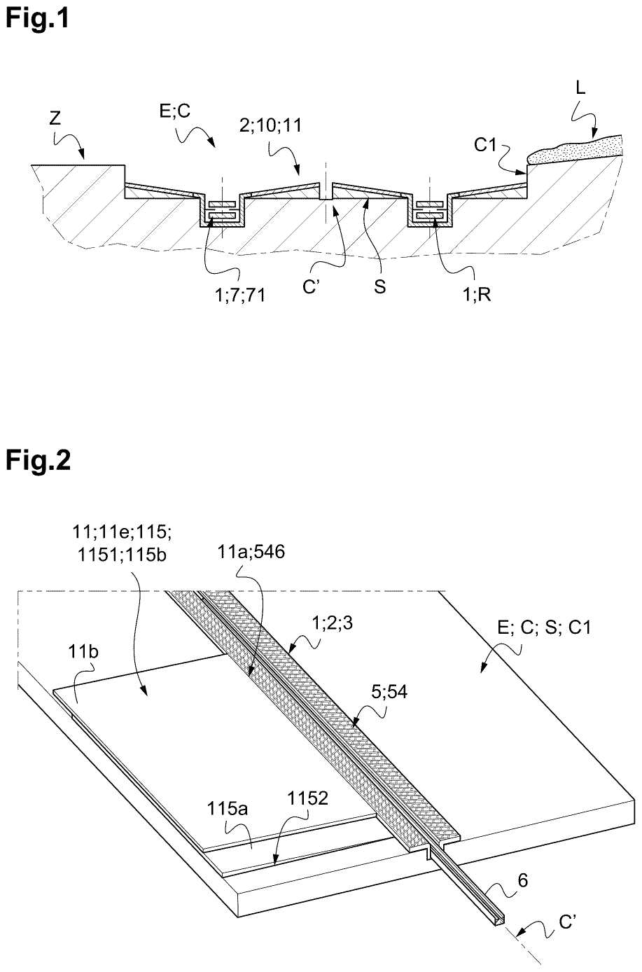

FIG. 1 is a cross-sectional overall view of a circulation corridor fitted with a collection system according to the invention;

FIG. 2 is a partial and perspective overall view of a circulation corridor fitted with a collection system according to the invention, which is also partially illustrated;

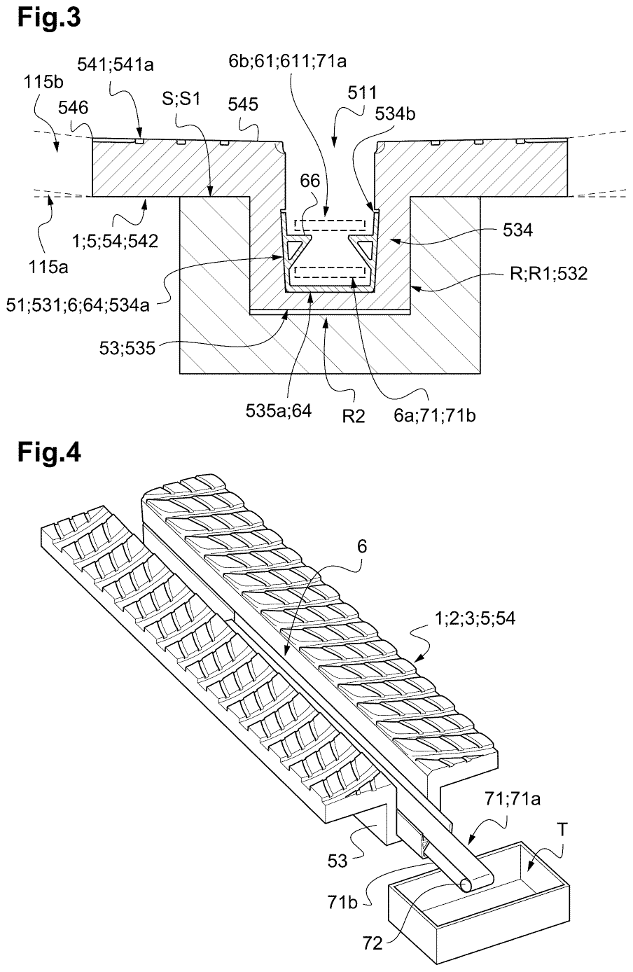

FIG. 3 is a partial and enlarged view of the circulation corridor according to FIG. 1, illustrating in more detail one of the stringers of the collection system according to the invention;

FIG. 4 is a partial and perspective overall view of a circulation corridor fitted with a collection system according to the invention;

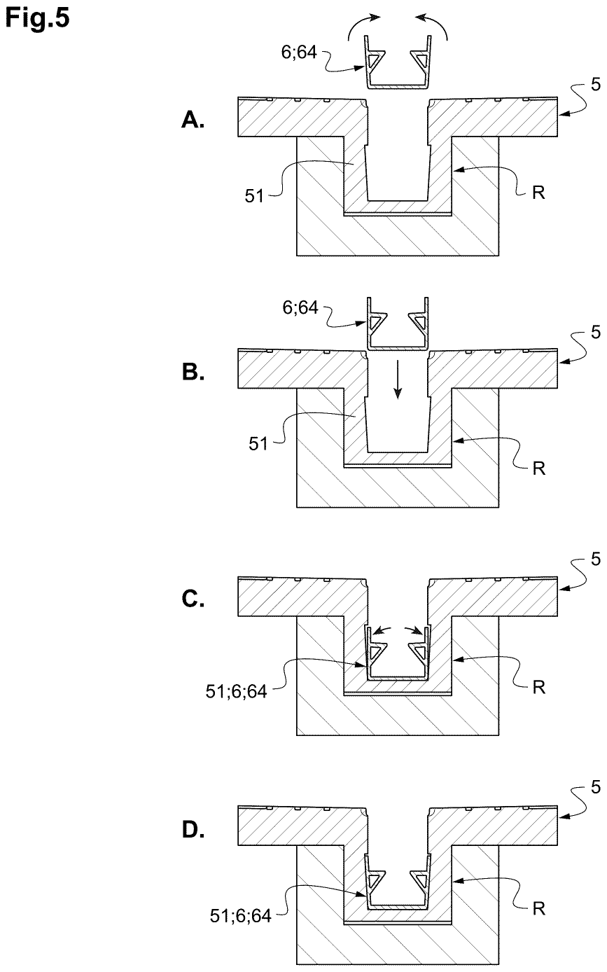

FIG. 5 is a cross-sectional view illustrating the main steps for assembling the stringer according to the invention.

It is to be noted that, in these figures, the structural and/or functional elements common to the different alternatives may have the same references.

The present invention also relates to a stringer 1 for a flooring 2, suitable for the ground S of an enclosure E for livestock, in particular cattle.

According to the invention, and as developed hereinafter, the flooring 2 is advantageously part of a collection system 3 that is suitable for collecting excreta flowing within the enclosure E.

As developed hereinafter, such a collection system 3 has for interest to collect the excreta (in particular, liquids) flowing on the ground S and to dispose them of, so as to provide an upper resting surface that is relatively dry (or at least without excessive humidity), and hence healthier and more securing, for the feet of the animals.

Such a collection system 3 is moreover advantageously adapted to collect the liquid excreta flowing on the ground and to separate them from the solid matters (for example, faeces, straw, etc.) in a continuous way and under the effect of gravity.

### Enclosure

The enclosure E according to the invention, as schematically and partially shown in FIG. 1, is adapted for livestock, for example cattle.

By “animals”, it is notably meant cattle (in particular, dairy cattle or beef cattle), pigs, or any other livestock animal (sheep, poultry, rabbits, horses, etc.).

Such a enclosure E consists of a building delimited by a frame (not shown), adapted for the desired livestock (for example, a stable in case of cattle).

Such an enclosure E includes a circulation corridor C that has a longitudinal axis C′ (see FIGS. 1 and 2). The longitudinal axis C′ advantageously forms a longitudinal central line of the circulation corridor C.

This circulation corridor C is also advantageously lined with two side borders C1.

Such circulation corridor C is used by animals moving between the various functional areas of the livestock enclosure E, for example the stalls L (on the right in FIG. 1), the feeding platforms Z possibly located in front of the fences (on the left in FIG. 1), milking parlours, etc.

Generally, the ground S advantageously consists of a screed, preferably made of bitumen or concrete.

The ground S includes at least one slot R that is advantageously made at the surface S1 of the ground S (possibly by a grooving operation), advantageously parallel to the longitudinal axis C′.

As illustrated in more details in FIG. 3, this slot R advantageously has a U-shaped cross-section (the ground S is partially shown).

This slot R advantageously has:
two side walls R1, facing each other and advantageously vertical, and
a bottom wall R2, advantageously horizontal.

For example, the width of the slot R (also corresponding to the distance separating its side walls R1) is 30 to 150 mm. And the height of the slot R (corresponding to the height of the side walls R1) is 30 to 80 mm.

As developed hereinafter, the enclosure E according to the invention advantageously includes:
a circulation corridor C, having the longitudinal axis C′ and fitted with a collection system 10 described hereinafter, and
collection means T (FIG. 4), for collecting excreta circulating along the above-mentioned collection system 10.

### Stringer

The stringer 1 according to the invention comprises:
a primary profile 5, made of an elastic material, having a longitudinal groove 51 and intended to be added into a slot R of the ground S, and preferably
a secondary profile 6, made of a plastic material, added into the longitudinal groove 51 of the primary profile 5 and defining a longitudinal groove 61.

This stringer 1, forming a gutter, is intended to receive the liquids flowing on the flooring 2.

The longitudinal groove 51 of the primary profile 5 forms, possibly in combination with the longitudinal slot 61 of the secondary profile 6, the longitudinal groove of the stringer 1.

The longitudinal groove 51 of the primary profile 5, and as the case may be, the longitudinal groove 61 of the secondary profile 6, advantageously includes two open ends, located at the collection means T and the open ends of the slot R of the floor S.

Preferably, the cross-section of the secondary profile 6 corresponds, to within the clearance, to the longitudinal groove 51 of the primary profile 5.

In practice, the stringer 1 advantageously comprises several primary profiles 5, in series, which are distributed end-to-end over the length of the slot R in the ground S.

The stringer 1 also advantageously comprises several secondary profiles 6, in series, which are distributed end-to-end over the length of the primary profiles 5.

As the case may be, the secondary profiles 6 are advantageously offset (for example, staggered) with respect to the primary profiles 5, to obtain optimum tightness and optimum guiding of the liquids.

Conveyor means 7 are advantageously provided to convey excreta within the longitudinal groove 51 of the primary profile 5 (or even, as the case may be, within the secondary profile 6), so as to generate a circulation of the excreta along said at least one longitudinal groove 51 and towards collection means T.

### Primary Profile

The primary profile 5 is made of an elastic material, i.e. also advantageously made of a material adapted to undergo an elastic deformation under the weight of an animal.

Such a material adapted to undergo an elastic deformation is advantageously chosen among:
the elastomeric materials, i.e. for example natural rubber, “synthetic natural” rubber (or synthetic polyisoprene), polybutadiene or styrene-budatiene, or
the plastic or thermoplastic elastomeric (TPE) materials, i.e. for example PVB (polyvinyl butyral), ABS (acrylonitrile butadiene styrene)/SBR (styrene-butadiene), PP (polypropylene)/EPDM (ethylene-propylene-diene monomer), TPU (polyurethane TPE).

This primary profile 5 advantageously includes a textile reinforcement (not shown), for example in the form of a reinforcement sub-layer.

This reinforcement sub-layer advantageously extends over the whole width of the primary profile 5.

Generally, the primary profile 5 has a thickness from 3 to 30 mm.

Still generally, this primary profile 5 advantageously comprises a central strip 53 and two side strips 54. This primary profile 5 thus has a generally T-shape.

The central strip 53 forms a rib intended to be housed in the complementary slot R arranged in the ground S.

For that purpose, this central strip 53 has two opposite faces:
a concave, upper face 531, defining the longitudinal groove 51 having a longitudinal opening 511 intended to open out upward, and
a convex, lower face 532, forming the rib.

In particular, the central strip 53 advantageously has:
two side walls 534 advantageously intended to conform the side walls R1 of the slot R, connected by
a bottom wall 535, advantageously intended to conform the bottom wall R2 of the slot R.

The side walls 534 and the bottom wall 535 define the longitudinal groove 51.

For example, the width of the longitudinal groove 51 (also corresponding to the distance separating its side walls 534) is 35 to 45 mm. And the height of the longitudinal groove 51 (corresponding to the height of the side walls 534) is 65 to 75 mm.

The side walls 534 advantageously extend:
perpendicular with respect to the bottom wall 534, or
diverging from the bottom wall 534, towards the longitudinal opening 511.

In other words, the longitudinal groove 51 of the primary profile 5 advantageously diverges from the bottom wall 535 towards the longitudinal opening 511.

The side walls 534 and the bottom wall 535 respectively have inner surfaces 534a, 535a defining the upper face 531 and the longitudinal groove 51.

The inner surfaces 534a of the side walls 534 advantageously extend:
perpendicular with respect to the bottom wall 534, or
diverging from the bottom wall 534, towards the longitudinal opening 511.

Still according to the invention, the inner surfaces 534a of the two side walls 534 of the central strip 53 are advantageously provided with stop means 534b suitable for an interlocking of the secondary profile 6 by elastic deformation.

These stop means 534b consist for example of:
longitudinal ribs, or
shoulders facing the bottom wall 535.

The two side strips 54, extending the central strip 53 and extending on either side of the longitudinal opening 511 of the longitudinal groove 51.

These two side strips 54 are each connected to one of the side walls 534 of the central strip 53.

These side strips 54 each include two opposite faces:
an upper surface 541, intended to form a resting surface for the animals, and
a lower face 542, intended to rest on the ground S, and in particular on the surface of the ground S1, along the slot R.

Each side strip 54 also has two opposite borders:
an inner border 545 connected to the central strip 53, and
a free, outer border 546, remote from the side strip 53.

Preferably, the side strips 54 have an increasing thickness from the central strip 53. In other words, the upper face 541 and the lower face 542 diverge relative to each other from the central strip 53.

For example, the thickness of each side strip 54 is of:
3 to 7 mm, on the side of the central strip 53 and at the inner border 545,
20 to 30 mm, remote from the central strip 53 and at the outer border 546.

Still preferably, the upper face 541 defines a slope from 2 to 5 %, with respect to the surface of the ground S1 and with respect to the horizontal. This feature ensures that any liquid present on the upper face 541 of the side strips 54 flows towards the longitudinal opening 511 of the longitudinal groove 51.

Still preferably, the side strips 54 have a width (on the side of the lower face 542, between the inner border 545 and the outer border 546) from 5 to 100 cm.

Still preferably, the upper face 541 of the side strips 54 include slots 541a opening out at the longitudinal opening 511 and/or an anti-slip relief.

In other words, the slots 541a advantageously extend over the width of the upper face 541 of the side strips 54 (from the outer border 546 to the inner border 545).

### Secondary Profile

The secondary profile 6, added in the longitudinal groove 51 of the central strip 53 of the primary profile 5, conforms this longitudinal groove 51.

This secondary profile 6 itself defines a longitudinal groove 61 having a longitudinal opening 611 opening out on the side of the longitudinal opening 511 of the longitudinal groove 51 of the primary profile 5.

Generally, the secondary profile 6 is useful to help guiding the liquids, and as the case may be, for the implantation of the conveyor means 7. This secondary profile 6, advantageously forming a guiding profile, is also advantageously useful to limit the frictions and to optimize the guiding of excreta.

Herein, the generally U-shaped secondary profile 6 advantageously has:
two side partitions 64, intended to conform the inner surfaces 534a of the side walls 534, and
a bottom partition 65, intended to conform the inner surface 535a of the bottom wall 535.

The side partitions 64 advantageously extend:
perpendicular with respect to the bottom partition 65, or
diverging from the bottom partition 65, towards the longitudinal opening 611.

Preferably, the bottom partition 65 conforms the inner surface 535a of the bottom wall 535. And the side partitions 64 diverge from the bottom partition 65, towards the longitudinal opening 611, with an upper angle with respect to the inner surfaces 534a of the side walls 534.

The dimensional characteristics enable the secondary profile 6 to be positioned into the primary profile 5 by an interlocking assembly using elastic deformation, in the presence of elastic deformation of the side partitions 64 of the secondary profile 6 in a rotational movement towards each other (FIG. 5).

The secondary profile 6 advantageously includes a discontinuous intermediate structure 66 extending between the side partitions 64 and remote from the bottom partition 65.

This intermediate structure 66 thus defines two chambers:
a lower chamber 6a, between the bottom partition 65 and the intermediate structure 66, and
an upper chamber 6b, between the intermediate structure 66 and the longitudinal opening 611.

These chambers 6a, 6b are advantageously intended to receive the conveyor means 7, as developed hereinafter.

### Collection System

The present invention also relates to a collection system 10, illustrated in particular in FIGS. 1 and 2, for collecting excreta flowing on the ground of the livestock enclosure E.

The collection system 10 comprises:
(i) a flooring 2 that comprises:
at least one stringer 1 according to the invention,
at least one pair of side blades 11 (only one of the side blades 11 is illustrated in FIG. 2), and
(ii) conveyor means 7 to convey excreta within said longitudinal groove 51 of said primary profile 5 (also forming the longitudinal groove of said at least one stringer 1), so as to generate a circulation of said excreta along said at least one longitudinal groove 51 and towards collection means T.

The side blades 11 are intended to be added on either side of the stringer 1.

Each side blade 11 has a downward slop towards said at least one longitudinal opening of the primary profile 5.

To ensure the flowing of the excreta towards the longitudinal groove 51 of the primary profile 5, the side blades 11 form a pair of “inclined” side blades 11 in which the two side blades 11 of a pair are separated by a stringer 1 as mentioned hereinabove.

The side blades 11 thus extend on either side of at least one stringer 1. In other words, at least one stringer 1 is interposed between the two side blades 11.

Each side blade 11 also has a downward slope towards at least one associated stringer 1.

The slope is directed perpendicular to the longitudinal axis C′ so that the side blades 11 define a concave dihedral face whose intersection line would be parallel to the longitudinal axis C′.

In other words, each side blade 11 includes two ends, defining its width R and parallel to the longitudinal axis C′, i.e.:
a lower end 11a, located near at least one stringer 1, and
an upper end 11b, located remote from said at least one stringer 1.

The lower end 11a of a side blade 11 is advantageously adjacent to an outer border 546 of a side strip 54.

The upper end 11b of a side blade 11 is advantageously adjacent to a side border C1 of the corridor C.

The side blade 11 thus slopes downwards from the upper end 11b to the lower end 11a.

Preferably, each side blade 11 has a slope from 1 to 5%, preferably from 2 to 4%.

Still preferably, each side blade 11 has a width from 500 to 2000 mm.

Still preferably, the side blades 11 each have an upper bearing face 11a, made of a material adapted to undergo an elastic deformation.

Such an upper bearing face 11a is then advantageously made of a material chosen among:
the elastomeric materials, i.e. for example natural rubber, “synthetic natural” rubber (or synthetic polyisoprene), polybutadiene or styrene-budatiene, or
the plastic or thermoplastic elastomeric (TPE) materials, i.e. for example PVB (polyvinyl butyral), ABS (acrylonitrile butadiene styrene)/SBR (styrene-butadiene), PP (polypropylene)/EPDM (ethylene-propylene-diene monomer), TPU (polyurethane TPE).

The upper bearing face 11e is advantageously flat, possibly provided with an anti-slip relief.

The anti-slip relief is for example a one-piece relief chosen from the reliefs used in floorings conventionally used in livestock buildings, such as diamond-shaped protruding elements with bosses.

According to an embodiment illustrated, the side blades 11 are advantageously each made of a stringer 115 of triangular cross-section, which are added on the surface of the ground S1 (advantageously horizontal).

Each stringer 115 advantageously has two opposite surfaces:
an upper surface 1151, corresponding to the upper resting face 11e, and
a lower surface 1152, intended to rest on the ground S.

These opposite surfaces 1151, 1152 converge from the upper end 11b towards the lower end 11a.

The upper surface 1151 is advantageously intended to be an extension of the upper face of a side strip 54.

Each stringer 115 can be composed of several superimposed layers, i.e. for example a base 115a that includes an inclined upper face on which is added an overlying layer 115b made of a material capable of elastic deformation.

The base 115a then advantageously defines the slope of the upper resting face 11e.

Here again, the base 115a has two opposite, converging surfaces, an upper one and a lower one.

The base 115a is advantageously made of a material selected from:
a concrete material, advantageously cast or prefabricated, or
a plastic material, preferably moulded or injected.

The base 115a is advantageously consisted of a succession of identical parts, arranged in series and adjoining longitudinally.

The overlying layer 115 b advantageously has a constant thickness, for example from 8 to mm.

This overlying layer 115b is advantageously continuous (for example, in the form of a continuous sheet or a continuous mat), and added on the base 115a. The overlying layer 115b can also be discontinuous, formed by juxtaposition of plates.

This overlying layer 115b potentially includes a reinforcement sub-layer or has no reinforcement sub-layer.

The connection between the base 115a and the overlying layer 115b is advantageously made by mechanical fasteners, passing through the stringer 115 to the ground S.

Moreover, the conveyor means 7 comprise a driving member 71 that is associated with operating means 72.

Herein, the driving member 71 advantageously has two superimposed parts in said at least one longitudinal groove 51:
an upper part 71a, advantageously in the upper chamber 6b of the secondary profile 6, adapted to convey solid excreta in a first conveying direction, while allowing the flowing of liquid excreta, and
a lower part 71b, advantageously in the lower chamber 6a, adapted to convey liquid excreta flowing from the upper part 71a, in a second conveying direction, which is opposite to said first direction.

Such an embodiment aims to favour disposal, on the one hand, of the solid excreta at a first end of the groove 51 of the primary profile 5 and, on the other hand, of the liquid excreta at a second end of the longitudinal groove 51 of the primary profile 5.

For that purpose, the driving member 71 advantageously comprises a belt (or strap or band) arranged to define two superimposed strands in the longitudinal groove 51 of the primary section 5:
an upper strand, travelling in a first direction, forming the upper part 71a of the driving member 71, and
a lower strand, travelling in a second direction, forming the lower part 71b of the driving member 7.

The strands 71a, 71b of the driving member 7 are advantageously each directed horizontally. These two strands 71a, 71b thus advantageously extend in two superimposed parallel planes.

Each strand 71a, 71b has a width advantageously from 40 to 100 mm.

Such a width is advantageous in terms of strength and assembly (e.g. by stapling).

Preferably, the driving member 71 is made one-piece, in an elastomeric material, i.e. for example natural rubber, “synthetic natural” rubber (or synthetic polyisoprene), polybutadiene or styrene-budatiene.

The operating means 72 are located at the open ends of the slot R in the ground S.

These operating means 72 consist for example of two pulleys with horizontal axes, at least one of which is motorized.

The collection means T comprise in particular a pit or a central outlet (very schematically shown in FIG. 4).

These collection means T are installed at one at least of the two open ends of the slot R of the ground S.

Preferably, the collection system 10 may also include means for scraping the flooring 2 surface.

These scraping means consist for example in a scraper blade whose lower border rests on the flooring 2 surface.

This planer is designed to be translated over the length of the flooring 2 to repel solids (faeces, straw, etc.) present on the upper surface of the flooring 2, up to the collection means T.

These scraping means can be chosen among the means conventional per se and known to the one skilled in the art.

### Installation and Embodiment

Installation of the collection system 10 according to the invention advantageously begins with the laying of the flooring 2.

This laying begins for example by the laying of said at least one stringer 1, then the side blades 11.

In particular, as shown in FIG. 5, the laying of the stringer 1 comprises the following successive steps:
positioning a primary profile 5 into a slot R of the ground S (FIG. 5A),
introducing a secondary profile 6 through the longitudinal opening 511 of the longitudinal groove 51 of the primary profile 5 (FIG. 5B to FIG. 5D).

In FIG. 5, the positioning of the secondary profile 6 into the primary profile 5 by an interlocking assembly using elastic deformation, in the presence of elastic deformation of the side partitions 64 of the secondary profile 6 in a rotational movement towards each other.

As the case may be, these different profiles 5, 6 are added and fastened to the ground S, for example through side strips 54 of the primary profile 5.

In operation, the upper surface of the flooring 2 is liable to receive different organic matters, in particular excreta (urine, faeces).

The side blades 11 and the side strips 54 then allow a flowing of the excreta up to the longitudinal opening 511 of the longitudinal groove 51, thus avoiding the accumulation of these liquids on the upper surface of the flooring 2, which thus remains relatively dry.

Solid matters, such as faeces and straw, tend to remain on the upper surface of the flooring 2, so as to avoid or at least limit the mixtures thereof with the liquid matters to limit the production of ammonia within the livestock enclosure and also to avoid that solid matters get caught on the conveyor means 7, to maintain an optimum action on the circulation of excreta within the longitudinal groove 51.

During a cleaning of this flooring 2, the cleaning liquid will also flow in said at least one longitudinal groove, avoiding that the upper surface of the flooring 2 remains excessively wet.

This phenomenon hence allows the animals to travel on a relatively healthy surface, with a reduced risk of fall and without humidification of their feet.

Advantageously, the liquids are concentrated in one or two longitudinal grooves 51, which as for interest to concentrate the liquids but also to simplify the installation and maintenance.

More generally, all the excreta flowing into said at least one longitudinal groove 51 are then efficiently disposed off towards the collection means T (in particular, the pit or the central outlet) by implementation of the conveyor means 7.

As the case may be, the driving members 72 are moved within said at least one longitudinal groove 51 (in a continuous or discontinuous manner), so as to generate the travel (continuous or discontinuous) of the excreta towards the dedicated collection means T.

The stringers 1 have for interest to efficiently channel these excreta and to reduce the friction efforts exerted on the conveyor means 7.

The conveyor means 7 hence allow a circulation and an active disposal of the excreta contained in said at least one longitudinal groove 51, to avoid their stagnation and to limit the development of ammonia and micro-organisms in the livestock enclosure.

Still generally, the collection system 10 according to the invention hence allows a rapid and continuous disposal of the excreta with respect to the upper surface of the flooring 2 and with respect to the livestock enclosure, which allows the latter to be efficiently kept in dry state (or at least without excess of humidity), hence limiting the problems of hygiene met with the usual floorings.

The collection system 10 according to the invention also allows a certain separation of the liquids that flow into said at least one longitudinal groove 51, with respect to the faeces and the straw that remain mainly on the surface of the flooring 2, so as to avoid their mixing and to limit the production of ammonia within the livestock enclosure.

Generally, the primary profile 5 provide protection of the secondary profile 6 against the stresses due to pressures on the ground.

This combination is also useful to make it easier to change the secondary profile 6 and the conveyor means 7.

The primary profile 5 being very stressed, this structure enables a mechanical fastening to the screed with spikes.

As this primary profile 5 is subject to heavy abrasion by mechanical scraping systems, it becomes a wear part that can be replaced without damaging the rest of the flooring 2.

Of course, various other modifications can be made to the invention within the scope of the appended claims.

1. A stringer for a flooring, suitable for the ground of an enclosure for livestock, in particular cattle,
said stringer (1) comprises a primary profile (5), made of an elastic material, which comprises a central strip (53) and two side strips (54),
said central strip (53), forming a rib intended to be housed in a complementary slot (R) formed in the floor, having two opposite faces:
a concave, upper face (531), defining the longitudinal groove (51) having a longitudinal opening (511) intended to open out upward, and
a convex, lower face (532), forming said rib, and
said two side strips (54), extending said central strip (53) and extending on either side of said longitudinal opening (511), having two opposite faces:
an upper surface (541), intended to form a resting surface for the animals, and
a lower surface (542), intended to rest on the ground, along said slot (R).

2. The stringer for a flooring, according to claim 1, wherein said primary profile (5) has a thickness from 3 to 30 mm.

3. The stringer for a flooring, according to claim 1, wherein the side strips (54) have a thickness that increases from the central strip (53).

4. The stringer for a flooring, according to claim 1, wherein the side strips (54) have a width from 5 to 100 cm.

5. The stringer for a flooring, according to claim 1, wherein said stringer (1) also comprises a secondary profile (6), made of a plastic material, added in the longitudinal groove (51) of said central strip (53) of the primary profile (5), said secondary profile (6) conforms said longitudinal groove (51) of the primary profile (5) and defines a longitudinal groove (61) having a longitudinal opening (611) that opens out towards the longitudinal opening (511) of said longitudinal groove (51) of the primary profile (5).

6. The stringer for a flooring, according to claim 5, wherein the secondary profile (6), generally U-shaped, has two side partitions (64) and a bottom partition (65).

7. The stringer for a flooring, according to claim 6, wherein the secondary profile (6) has a discontinuous intermediate structure (66) extending between the side partitions (64) and remote from the bottom partition (65), to define a lower chamber (6a) and an upper chamber (6b) intended to receive conveyor means (7) comprising a driving member (71) that is associated with operating means (72).

8. A system for collecting the excreta flowing on the ground of an enclosure (E) for livestock, for example cattle, said collection system being wherein it comprises:
(i) a flooring (2) that comprises:
at least one stringer (1) according to claim 1,
at least one pair of side blades (11), intended to be added on either side of said stringer (1) and each having a downward slope towards said at least one longitudinal opening (511) of the primary profile (5),
(ii) conveyor means (7) for conveying the excreta within said longitudinal groove (51) of said at least one primary profile (5), so as to generate a circulation of said excreta along said at least one longitudinal groove (51) of said at least one primary profile (5) and towards collection means (T), said conveyor means (7) comprise a driving member (71) that is associated with operating means (72).

9. The collection system, according to claim 8, wherein each side blade (11) has a slope from 1 to 5 %.

10. The collection system, according to claim 8, wherein each side blade (11) has a width from 500 to 2000 mm.

11. The collection system, according to claim 8, wherein said driving member (71) includes two superimposed parts in said at least one longitudinal groove (51):
an upper part (71a), adapted to convey solid excreta in a first conveying direction, while allowing the flowing of liquid excreta, and
a lower part (71b), adapted to convey liquid excreta flowing from said upper part (71a), in a second conveying direction, which is opposite to said first direction.

12. An enclosure (E) for livestock, for example cattle, wherein said enclosure (E) includes:
a circulation corridor (C), having a longitudinal axis (C′) and fitted with a collection system (10) according to claim 8,
collection means (T) for collecting excreta circulating along said at least one longitudinal groove (51) of said primary profile (5).

13. The collection system, according to claim 8, wherein, wherein said primary profile (5) has a thickness from 3 to 30 mm.

14. The collection system, according to claim 8, wherein, wherein the side strips (54) have a thickness that increases from the central strip (53).

15. The collection system, according to claim 8, wherein, wherein the side strips (54) have a width from 5 to 100 cm.

16. The collection system, according to claim 8, wherein, wherein said stringer (1) also comprises a secondary profile (6), made of a plastic material, added in the longitudinal groove (51) of said central strip (53) of the primary profile (5),
said secondary profile (6) conforms said longitudinal groove (51) of the primary profile (5) and defines a longitudinal groove (61) having a longitudinal opening (611) that opens out towards the longitudinal opening (511) of said longitudinal groove (51) of the primary profile (5).

17. The collection system, according to claim 16, wherein the secondary profile (6), generally U-shaped, has two side partitions and a bottom partition (65).

18. The collection system, according to claim 17, wherein the secondary profile (6) has a discontinuous intermediate structure (66) extending between the side partitions (64) and remote from the bottom partition (65), to define a lower chamber (6a) and an upper chamber (6b) intended to receive conveyor means (7) comprising a driving member (71) that is associated with operating means (72).
